(19) United States
(12) Patent Application Publication
(10) Pub. No.: US 2026/0170622 A1
(43) Pub. Date: Jun. 18, 2026

(54) IMAGE GENERATION METHOD AND IMAGE GENERATION SYSTEM USING THE SAME

(71) Applicant: Acer Incorporated, New Taipei City (TW)

(72) Inventors: Chi-Kang LEE, New Taipei City (TW); Wen-Cheng HSU, New Taipei City (TW); Shih-Hao LIN, New Taipei City (TW); Chieh-Sheng WANG, New Taipei City (TW)

(73) Assignee: Acer Incorporated, New Taipei City (TW)

(21) Appl. No.: 19/341,222

(22) Filed: Sep. 26, 2025

(30) Foreign Application Priority Data
Dec. 12, 2024 (TW) 113148503

(51) Int. Cl. G06T 5/77; G06T 1/00; G06T 3/4046; G06T 5/60; G06T 11/00

(52) U.S. Cl. CPC G06T 5/77; G06T 1/0021; G06T 3/4046; G06T 5/60; G06T 11/00; G06T 2207/20084

(57) ABSTRACT

An image generation method and an image generation system using the same are provided. The image generation method includes the following steps. A text-to-image conversion procedure is executed according to a prompt to generate a basic image. An image out-painting procedure is executed according to the basic image to obtain an out-painted image. A resolution adjustment procedure is executed to adjust a resolution of the out-painted image and an adjusted resolution image is obtained. A hidden watermark synthesis procedure is executed to synthesize a hidden watermark on the adjusted resolution image and a generated image is obtained. The text-to-image conversion procedure, the image out-painting procedure, the resolution adjustment procedure and the hidden watermark synthesis procedure are executed in a pipeline manner through a Graphic Processing Unit (GPU) and a Neural network Processing Unit (NPU).

This application claims the benefit of Taiwan application Serial No. 113148503, filed Dec. 12, 2024, the disclosure of which is incorporated by reference herein in its entirety.

### TECHNICAL FIELD

The disclosure relates in general to an artificial intelligence (AI) method and an AI system using the same, and more particularly to an image generation method and an image generation system using the same.

### BACKGROUND

With the rapid development of artificial intelligence (AI), various image generation and modification technologies have emerged. However, currently, using AI to execute multiple programs consumes enormous system resources. For example, a 16 GB NVIDIA 2080 is required to generate a 1280×720 AI image. This makes AI difficult to implement on various laptops.

Therefore, how to effectively reduce system resources and shorten image processing time is the direction the industry is currently working to solve.

### SUMMARY

This disclosure is directed to an image generation method and an image generation system employing the same. The method utilizes a pipeline approach to execute a text-to-image conversion procedure, an image out-painting procedure, a resolution adjustment procedure, and a hidden watermark synthesis procedure, significantly increasing the speed of image generation.

According to one embodiment, an image generation method is provided. The image generation method includes the following steps. A text-to-image conversion procedure is executed according to a prompt to generate a basic image. An image out-painting procedure is executed according to the basic image to obtain an out-painted image. A resolution adjustment procedure is executed to adjust a resolution of the out-painted image and then obtain an adjusted resolution image. A hidden watermark synthesis procedure is executed to synthesize a hidden watermark on the adjusted resolution image and then obtain a generated image. The text-to-image conversion procedure, the image out-painting procedure, the resolution adjustment procedure and the hidden watermark synthesis procedure are executed in a pipeline manner through a Graphic Processing Unit (GPU) and a Neural network Processing Unit (NPU).

According to another embodiment, an image generation system is provided. The image generation system includes a text-to-image module, an image extension module, a resolution adjustment module, and a hidden watermark synthesis module. The text-to-image module is used for executing a text-to-image conversion procedure according to a prompt to generate a basic image. The image extension module is used for executing an image out-painting procedure according to the basic image to obtain an out-painted image. The resolution adjustment module is used for executing a resolution adjustment procedure to adjust a resolution of the out-painted image and then obtain an adjusted resolution image. The hidden watermark synthesis module is used for executing a hidden watermark synthesis procedure to synthesize a hidden watermark on the adjusted resolution image and then obtain a generated image. The text-to-image conversion procedure, the image out-painting procedure, the resolution adjustment procedure and the hidden watermark synthesis procedure are executed in a pipeline manner through a Graphic Processing Unit (GPU) and a Neural network Processing Unit (NPU).

According to an alternative embodiment, an image generation method is provided. The image generation method includes the following steps. A text-to-image conversion procedure is executed according to a prompt to generate a basic image. An image out-painting procedure is executed according to the basic image to obtain an out-painted image. A resolution adjustment procedure is executed to adjust a resolution of the out-painted image and then obtain an adjusted resolution image. A hidden watermark synthesis procedure is executed to synthesize a hidden watermark on the adjusted resolution image and then obtain a generated image. In the image out-painting procedure, the resolution adjustment procedure and the hidden watermark synthesis procedure, an intermediate calculation result is directly obtained from a memory of the graphic processing unit or a memory of the neural network processing unit.

### BRIEF DESCRIPTION OF THE DRAWINGS

FIG. 1 illustrates an image generation method according to an embodiment of the present disclosure.

FIG. 2 illustrates an example of executing the text-to-image conversion procedure, the image out-painting procedure, the resolution adjustment procedure, and the hidden watermark synthesis procedure in a pipeline manner.

FIG. 3 shows a block diagram of the image generation system according to an embodiment disclosed in this disclosure.

FIG. 4 shows a flowchart of the image generation method according to the disclosed embodiment.

FIG. 5 illustrates the image out-painting procedure.

FIG. 6 illustrates the relationship between the pre-processed image and the to-be-drawn images.

FIG. 7 illustrates zero copy in the disclosed image generation method.

FIG. 8 illustrates another method for implementing zero-copy in the image generation method disclosed herein.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

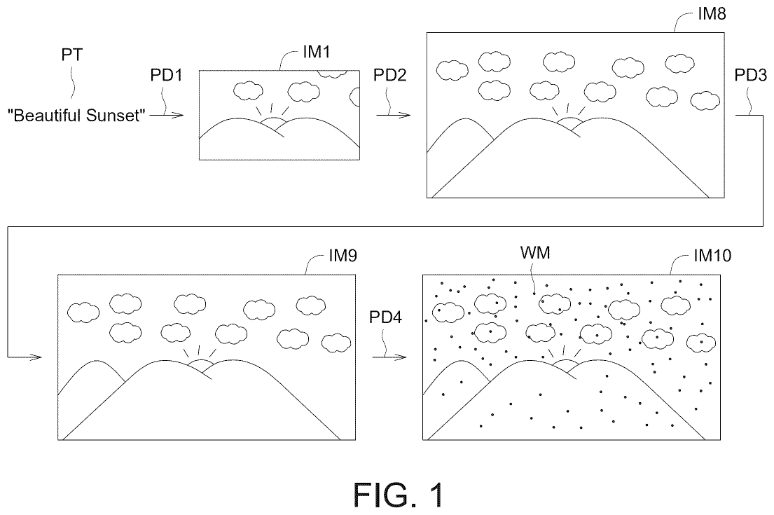

Please refer to FIG. 1, which illustrates an image generation method according to an embodiment of the present disclosure. The image generation method includes, for example, a text-to-image conversion procedure PD1, an image out-painting procedure PD2, a resolution adjustment procedure PD3, and a hidden watermark synthesis procedure PD4. In the text-to-image conversion procedure PD1, artificial intelligence (AI) is used to generate a basic image IM1 based on the prompt PT. Next, in the image out-painting procedure PD2, a basic image IM1 is expanded and extended to obtain an out-painted image IM8. Then, in the resolution adjustment procedure PD3, the resolution of the out-painted image IM8 is adjusted to obtain an adjusted-resolution image IM9. Next, in the hidden watermark synthesis procedure PD4, the hidden watermark WM is added to the out-painted image IM8 to obtain a generated image IM10. The hidden watermark WM is scattered across several pixels in the generated image, making its presence imperceptible to the human eye.

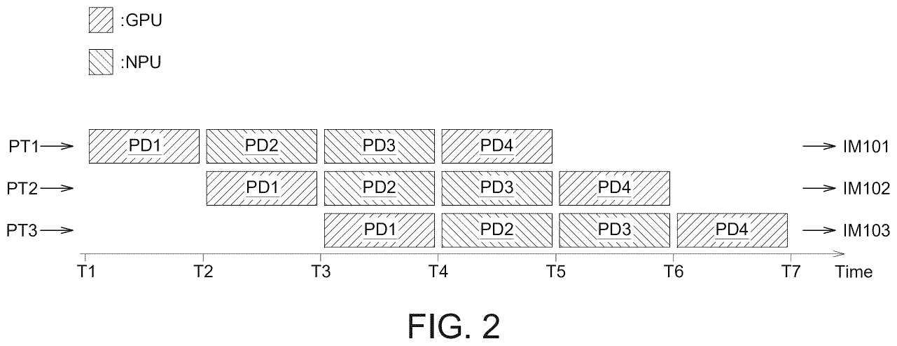

Please refer to FIG. 2, which illustrates an example of executing the text-to-image conversion procedure PD1, the image out-painting procedure PD2, the resolution adjustment procedure PD3, and the hidden watermark synthesis procedure PD4 in a pipeline manner. In this embodiment, the four procedures (the text-to-image conversion procedure PD1, the image out-painting procedure PD2, the resolution adjustment procedure PD3, and the hidden watermark synthesis procedure PD4) are executed in a pipeline manner using, for example, a graphics processing unit GPU and a neural network processing unit NPU.

For example, as shown in FIG. 2, from the time point T1 to the time point T2, the graphics processing unit GPU could execute the text-to-image conversion procedure PD1 according to the prompt PT1.

Next, as shown in FIG. 2, from the time point T2 to the time point T3, the neural network processing unit NPU executes the image out-painting procedure PD2 according to the prompt PT1, while the graphics processing unit GPU executes the text-to-image conversion procedure PD1 according to the prompt PT2.

Then, as shown in FIG. 2, from the time point T3 to the time point T4, the neural network processing unit NPU executes the resolution adjustment procedure PD3 according to the prompt PT1 and executes the image out-painting procedure PD2 according to the prompt PT2, while the graphics processing unit GPU executes the text-to-image conversion procedure PD1 according to the prompt PT3.

Next, as shown in FIG. 2, from the time point T4 to the time point T5, the graphics processing unit GPU executes the hidden watermark synthesis procedure PD4 according to the prompt PT1, executes the image out-painting procedure PD2 according to the prompt PT3, and executes the resolution adjustment procedure PD3 according to the prompt PT3. The same process continues at the time points T6 and T7, resulting in generated images IM101, IM102, and IM103.

That is, in this embodiment, the image generation method is executed in a pipeline manner, and the graphic processing unit GPU and the neural network processing unit NPU could be used to execute multiple procedures simultaneously to speed up the processing speed.

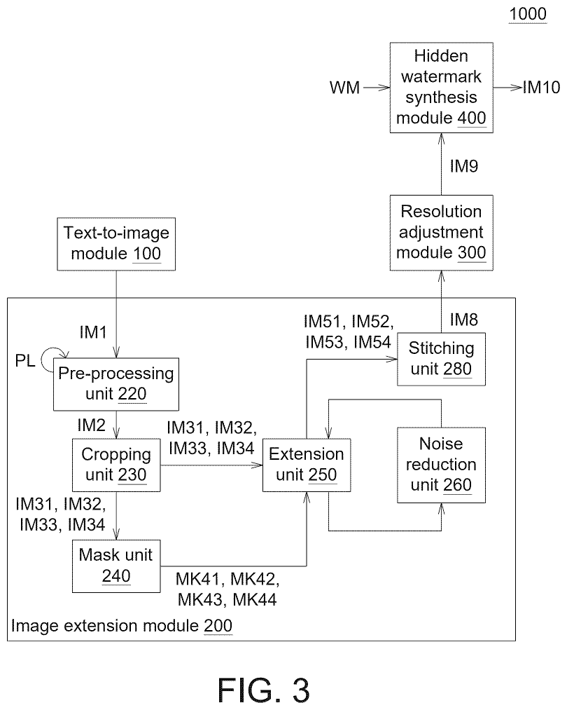

Please refer to the FIG. 3, which shows a block diagram of the image generation system 1000 according to an embodiment disclosed in this disclosure. The image generation system 1000 includes a text-to-image module 100, an image extension module 200, a resolution adjustment module 300 and a hidden watermark synthesis module 400. The text-to-image module 100 is used to convert text into an image. The image extension module 200 is used to extend the image. The resolution adjustment module 300 is used to adjust the image resolution. The hidden watermark synthesis module 400 is used to add a watermark to the image.

As shown in FIG. 3, the image extension module 200 includes a pre-processing unit 220, a cropping unit 230, a mask unit 240, an extension unit 250, a noise reduction unit 260 and a stitching unit 280. The text-to-image module 100, the pre-processing unit 220, the cropping unit 230, the mask unit 240, extension unit 250, the noise reduction unit 260, the stitching unit 280 of the image extension module 200, the resolution adjustment module 300 and/or the hidden watermark synthesis module 400 is, for example, a circuit, a circuit board, a storage device for storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof. The text-to-image module 100, the image extension module 200, the resolution adjustment module 300 and the hidden watermark synthesis module 400 of the image generation system 1000 respectively execute the text-to-image conversion procedure PD1, the image out-painting procedure PD2, the resolution adjustment procedure PD3 and the hidden watermark synthesis procedure PD4. The following is a flowchart that details the operation of each component.

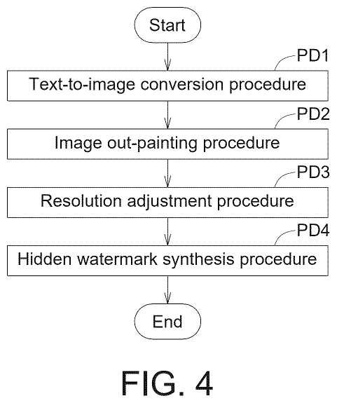

Please refer to FIG. 3 and FIG. 4 at the same time. FIG. 4 shows a flowchart of the image generation method according to the disclosed embodiment. First, as shown in FIG. 1, in the text-to-image conversion procedure PD1, the text-to-image module 100 generates the basic image IM1 according to the prompt PT. For example, when a user inputs the prompt PT from “Beautiful Sunset”, the text-to-image module 100 will use artificial intelligence image generation technology to generate a landscape image with sunset.

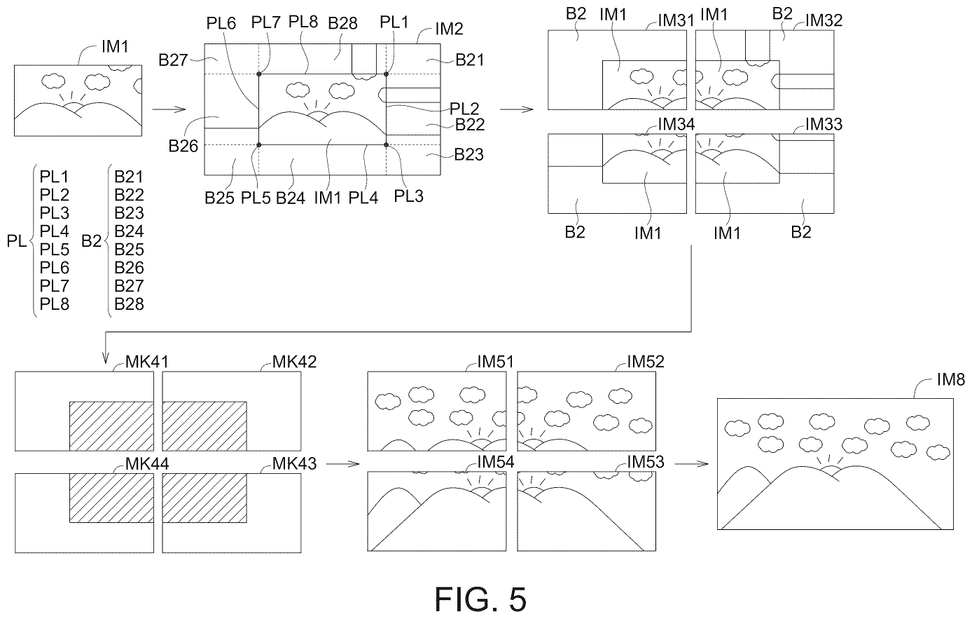

Next, please refer to FIGS. 3 and 5. FIG. 5 illustrates the image out-painting procedure PD2. In this procedure, the image extension module 200 obtains an out-painted image IM8 according to the basic image IM1. The pre-processing unit 220 of the image extension module 200 fills a ring block B2 surrounding the basic image IM1 with several edge pixels PL from the basic image IM1 to obtain a pre-processed image IM2.

The ring block B2 includes a plurality of corner blocks B21, B23, B25, and B27, and a plurality of rectangular connected blocks B22, B24, B26, and B28. The rectangular connected block B22 connects the corner block B21 and the corner block B23; the rectangular connected block B24 connects the corner block B23 and the corner block B25; the rectangular connected block B26 connects the corner block B25 and the corner block B27; and the rectangular connected block B28 connects the corner block B27 and the corner block B21.

The edge pixels PL include a plurality of corner pixels PL1, PL3, PL5, and PL7, and a plurality of side pixels PL2, PL4, PL6, and PL8. The side pixels PL2 are located between the corner pixel PL1 and the corner pixel PL3; the side pixels PL4 are located between the corner pixel PL3 and the corner pixel PL5; the side pixels PL6 are located between the corner pixel PL5 and the corner pixel PL7; and the side pixels PL8 are located between the corner pixel PL7 and the corner pixel PL1.

The corner block B21 is filled with the corner pixel PL1 of the basic image IM1; the rectangular connected block B22 is filled with the side pixels PL2 of the basic image IM1; the corner block B23 is filled with the corner pixel PL3 of the basic image IM1; the rectangular connected block B24 is filled with the side pixels PL4 of the basic image IM1; the corner block B25 is filled with the corner pixel PL5 of the basic image IM1; the rectangular connected block B26 is filled with the side pixels PL6 of the basic image IM1; the corner block B27 is filled with the corner pixel PL7 of the basic image IM1; and the rectangular connected block B28 is filled with the side pixels PL8 of the basic image IM1. The filling operation could improve the accuracy and speed of the image extension. In one embodiment, the filling operation could be omitted.

Next, as shown in FIGS. 3 and 5, the cropping unit 230 of the image extension module 200 crops the pre-processed image IM2 into four to-be-drawn images IM31, IM32, IM33, and IM34. The to-be-drawn image IM31 consists of the upper left corner of the basic image IM1 and the upper left corner of the ring block B2; the to-be-drawn image IM32 consists of the upper right corner of the basic image IM1 and the upper right corner of the ring block B2; the to-be-drawn image IM33 consists of the lower right corner of the basic image IM1 and the lower right corner of the ring block B2; the to-be-drawn image IM34 consists of the lower left corner of the basic image IM1 and the lower left corner of the ring block B2. The dimensions of these to-be-drawn images IM31, IM32, IM33, and IM34 are substantially the same.

In one embodiment, the to-be-drawn images IM31, IM32, IM33, and IM34 include portions of the basic image IM1 that are identical in size. In another embodiment, the to-be-drawn images IM31, IM32, IM33, and IM34 may include portions of the basic image IM1 that are not identical in size.

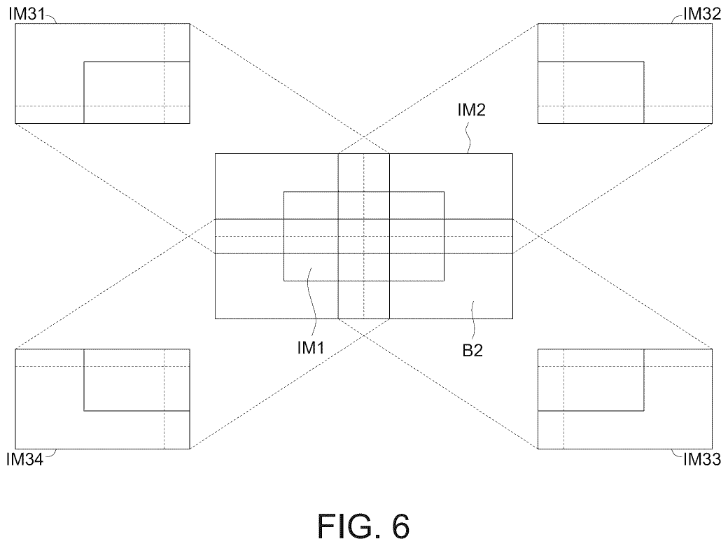

Please refer to FIG. 6, which illustrates the relationship between the pre-processed image IM2 and the to-be-drawn images IM31, IM32, IM33, and IM34. The to-be-drawn images IM31, IM32, IM33, and IM34 partially overlap at the edges to facilitate image stitching.

Next, as shown in FIGS. 3 and 5, the mask unit 240 of the image extension module 200 generates a plurality of masks MK41, MK42, MK43, and MK44 according to the to-be-drawn images IM31, IM32, IM33, and IM34. In each of the masks MK41, MK42, MK43, and MK44, pixels corresponding to 0 (the shaded area) do not require content extension, while pixels corresponding to 1 (the blank area) do. In other words, the basic image IM1 corresponding to pixels 0 is retained, and only the ring block B2 corresponding to pixels 1 requires content extension.

Then, as shown in FIGS. 3 and 5, the extension unit 250 of the image extension module 200 expands the contents of portions of the ring block B2 within the to-be-drawn images IM31, IM32, IM33, and IM34 according to the masks MK41, MK42, MK43, and MK44, generating a plurality of drawn images IM51, IM52, IM53, and IM54. Because the expansion of the to-be-drawn images IM31, IM32, IM33, and IM34 is performed separately in a pipelined manner, computing and memory resources are not consumed simultaneously.

During the step of expanding the contents of portions of the ring block B2 within the to-be-drawn images IM31, IM32, IM33, and IM34, positive prompts were used for content expansion, without the need for negative prompts. In other words, the researchers found that negative prompts were not very helpful for content expansion. Therefore, omitting negative prompts and using only positive prompts for content expansion could increase expansion speed while maintaining a certain level of accuracy.

Next, as shown in FIGS. 3 and 5, the noise reduction unit 260 of the image extension module 200 executes noise reduction on the drawn images IM51, IM52, IM53, and IM54.

Then, as shown in FIGS. 3 and 5, the stitching unit 280 of the image extension module 200 stitches the drawn images IM51, IM52, IM53, and IM54 together to produce an out-painted image IM8. Because the to-be-drawn images IM31, IM32, IM33, and IM34 partially overlap at their edges, the drawn images IM51, IM52, IM53, and IM54 are stitched together smoothly without any abrupt lines.

Next, as shown in FIGS. 1 and 3, in the resolution adjustment procedure PD3, the resolution adjustment module 300 adjusts the resolution of the out-painted image IM8 to obtain the adjusted resolution image IM9. In this procedure, the resolution of the out-painted image IM8 could be adjusted according to the resolution of the display.

Then, as shown in FIGS. 1 and 3, in the hidden watermark synthesis procedure PD4, the hidden watermark synthesis module 400 synthesizes the hidden watermark WM on the adjusted resolution image IM9 to obtain the generated image IM10.

In the above embodiment, the pipeline manner could be used to execute the text-to-image conversion procedure PD1, the image out-painting procedure PD2, the resolution adjustment procedure PD3, and the hidden watermark synthesis procedure PD4 using the graphics processing unit GPU and the neural network processing unit NPU. Multiple procedures could be executed simultaneously, significantly accelerating processing speed.

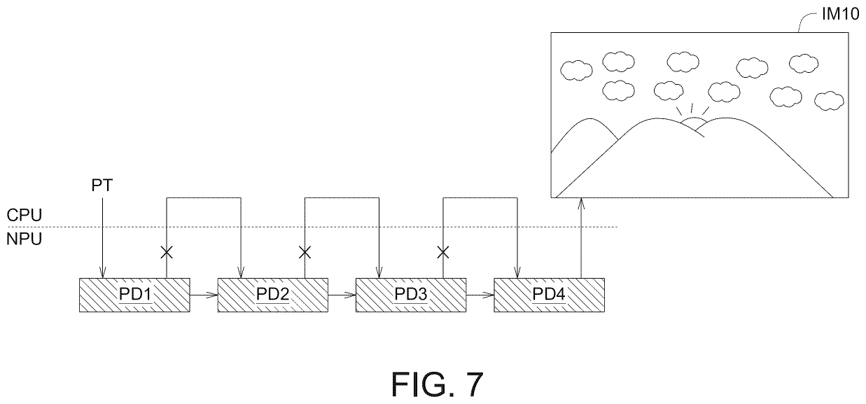

Please refer to FIG. 7, which illustrates zero copy in the disclosed image generation method. In the embodiment of FIG. 7, the neural network processing unit NPU is used to execute the text-to-image conversion procedure PD1, the image out-painting procedure PD2, the resolution adjustment procedure PD3, and the hidden watermark synthesis procedure PD4. After executing the text-to-image conversion procedure PD1, the intermediate calculation results are stored in the memory of the neural network processing unit NPU. During the image out-painting procedure PD2, the intermediate calculation results of the text-to-image conversion procedure PD1 are directly obtained from the memory of the neural network processing unit NPU. After executing the image out-painting procedure PD2, the intermediate calculation results are stored in the memory of the neural network processing unit NPU. During the resolution adjustment procedure PD3, the intermediate calculation results of the image out-painting procedure PD2 are directly retrieved from the memory of the neural network processing unit NPU. After executing the resolution adjustment procedure PD3, the intermediate calculation results are stored in the memory of the neural network processing unit NPU. During the resolution adjustment procedure PD3, the intermediate calculation results of the hidden watermark synthesis procedure PD4 are directly retrieved from the memory of the neural network processing unit NPU.

In the embodiment of FIG. 7, the intermediate calculation results do not need to be sent to the central processing unit CPU first. The neural network processing unit NPU directly retrieves the intermediate calculation results from its own memory, which could significantly save data transfer time.

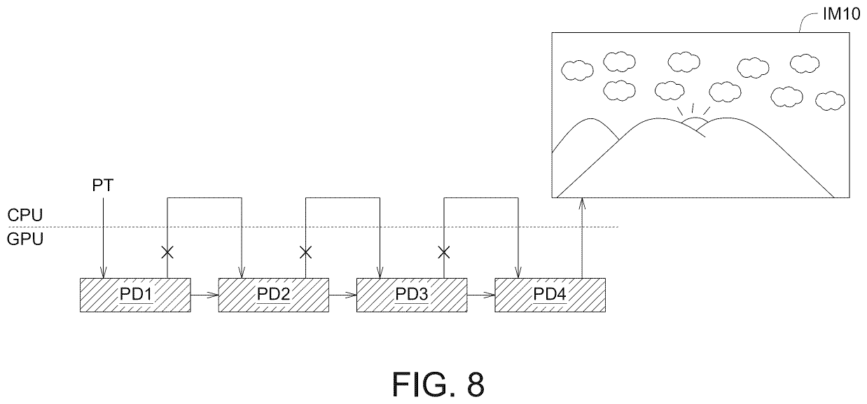

Please refer to FIG. 8, which illustrates another method for implementing zero-copy in the image generation method disclosed herein. In the embodiment of FIG. 8, the graphics processing unit GPU is used to execute the text-to-image conversion procedure PD1, the image out-painting procedure PD2, the resolution adjustment procedure PD3, and the hidden watermark synthesis procedure PD4. After executing the text-to-image conversion procedure PD1, the intermediate calculation results are stored in the memory of the graphics processing unit GPU. During the image out-painting procedure PD2, the intermediate calculation results of the text-to-image conversion procedure PD1 are directly retrieved from the memory of the graphics processing unit GPU. After executing the image out-painting procedure PD2, the intermediate calculation results are also stored in the memory of the graphics processing unit GPU. During the resolution adjustment procedure PD3, the intermediate calculation results of the image out-painting procedure PD2 are directly retrieved from the memory of the graphics processing unit GPU. After executing resolution adjustment procedure PD3, the intermediate calculation results are stored in the memory of the graphics processing unit GPU. During the resolution adjustment procedure PD3, the intermediate calculation results of the hidden watermark synthesis procedure PD4 are directly retrieved from the memory of the graphics processing unit GPU.

In the embodiment of FIG. 8, the intermediate calculation results do not need to be sent to the center processing unit CPU first. The graphic processing unit GPU directly takes the intermediate calculation results from its own memory, which could significantly save data handling time.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An image generation method, comprising:
executing a text-to-image conversion procedure according to a prompt to generate a basic image;
executing an image out-painting procedure according to the basic image to obtain an out-painted image;
executing a resolution adjustment procedure to adjust a resolution of the out-painted image and then obtain an adjusted resolution image; and
executing a hidden watermark synthesis procedure to synthesize a hidden watermark on the adjusted resolution image and then obtain a generated image;
wherein the text-to-image conversion procedure, the image out-painting procedure, the resolution adjustment procedure and the hidden watermark synthesis procedure are executed in a pipeline manner through a Graphic Processing Unit (GPU) and a Neural network Processing Unit (NPU).

2. The image generation method according to claim 1, wherein in the image out-painting procedure, the resolution adjustment procedure and the hidden watermark synthesis procedure, an intermediate calculation result is directly obtained from a memory of the graphic processing unit or a memory of the neural network processing unit.

3. The image generation method according to claim 2, wherein the image out-painting procedure comprises:
filling a ring block surrounding the basic image, by using a plurality of edge pixels of the basic image, to obtain a pre-processed image;
cropping the pre-processed image into a plurality of to-be-drawn images, each of which includes part of the basic image and part of the ring block;
obtaining a plurality of masks according to the to-be-drawn images;
expanding part of the ring block in each of the to-be-drawn images based on the masks to obtain a plurality of drawn images; and
stitching the drawn images to obtain the out-painted image.

4. The image generation method according to claim 3, wherein the ring block includes a plurality of corner blocks and a plurality of rectangular connected blocks, the edge pixels include a plurality of corner pixels and a plurality of side pixels, the rectangular connected blocks connect the corner blocks, the corner blocks are filled with the corner pixels of the basic image, and the rectangular connected blocks are filled with the side pixels of the basic image.

5. The image generation method according to claim 3, wherein sizes of the to-be-drawn images are substantially identical.

6. The image generation method according to claim 3, wherein the to-be-drawn images contain parts of the basic image with identical size.

7. The image generation method according to claim 3, wherein number of the to-be-drawn images is 4.

8. The image generation method according to claim 3, wherein the to-be-drawn images partially overlap.

9. The image generation method according to claim 3, wherein in each of the masks, pixels corresponding to 0 do not need to be expanded, and pixels corresponding to 1 need to be expanded.

10. An image generation system, comprising:
a text-to-image module, used for executing a text-to-image conversion procedure according to a prompt to generate a basic image;
an image extension module, used for executing an image out-painting procedure according to the basic image to obtain an out-painted image;
a resolution adjustment module, used for executing a resolution adjustment procedure to adjust a resolution of the out-painted image and then obtain an adjusted resolution image; and
a hidden watermark synthesis module, used for executing a hidden watermark synthesis procedure to synthesize a hidden watermark on the adjusted resolution image and then obtain a generated image;
wherein the text-to-image conversion procedure, the image out-painting procedure, the resolution adjustment procedure and the hidden watermark synthesis procedure are executed in a pipeline manner through a Graphic Processing Unit (GPU) and a Neural network Processing Unit (NPU).

11. The image generation system according to claim 10, wherein in the image out-painting procedure, the resolution adjustment procedure and the hidden watermark synthesis procedure, an intermediate calculation result is directly obtained from a memory of the graphic processing unit or a memory of the neural network processing unit.

12. The image generation system according to claim 10, wherein the image extension module comprises:
a pre-processing unit, used for filling a ring block surrounding the basic image, by using a plurality of edge pixels of the basic image, to obtain a pre-processed image;
a cropping unit, used for cropping the pre-processed image into a plurality of to-be-drawn images, each of which includes part of the basic image and part of the ring block;
a mask unit, used for obtaining a plurality of masks according to the to-be-drawn images;
an extension unit, used for expanding part of the ring block in each of the to-be-drawn images based on the masks to obtain a plurality of drawn images; and
a stitching unit, used for stitching the drawn images to obtain the out-painted image.

13. The image generation system according to claim 12, wherein the ring block includes a plurality of corner blocks and a plurality of rectangular connected blocks, the edge pixels include a plurality of corner pixels and a plurality of side pixels, the rectangular connected blocks connect the corner blocks, the corner blocks are filled with the corner pixels of the basic image, and the rectangular connected blocks are filled with the side pixels of the basic image.

14. The image generation system according to claim 12, wherein sizes of the to-be-drawn images are substantially identical.

15. The image generation system according to claim 12, wherein the to-be-drawn images contain parts of the basic image with identical size.

16. An image generation method, comprising:
executing a text-to-image conversion procedure according to a prompt to generate a basic image;
executing an image out-painting procedure according to the basic image to obtain an out-painted image;
executing a resolution adjustment procedure to adjust a resolution of the out-painted image and then obtain an adjusted resolution image; and
executing a hidden watermark synthesis procedure to synthesize a hidden watermark on the adjusted resolution image and then obtain a generated image;
wherein in the image out-painting procedure, the resolution adjustment procedure and the hidden watermark synthesis procedure, an intermediate calculation result is directly obtained from a memory of the graphic processing unit or a memory of the neural network processing unit.

17. The image generation method according to claim 16, wherein the image out-painting procedure comprises:
filling a ring block surrounding the basic image, by using a plurality of edge pixels of the basic image, to obtain a pre-processed image;
cropping the pre-processed image into a plurality of to-be-drawn images, each of which includes part of the basic image and part of the ring block;
obtaining a plurality of masks according to the to-be-drawn images;
expanding part of the ring block in each of the to-be-drawn images based on the masks to obtain a plurality of drawn images; and
stitching the drawn images to obtain the out-painted image.

18. The image generation method according to claim 17, wherein the ring block includes a plurality of corner blocks and a plurality of rectangular connected blocks, the edge pixels include a plurality of corner pixels and a plurality of side pixels, the rectangular connected blocks connect the corner blocks, the corner blocks are filled with the corner pixels of the basic image, and the rectangular connected blocks are filled with the side pixels of the basic image.

19. The image generation method according to claim 17, wherein sizes of the to-be-drawn images are substantially identical.

20. The image generation method according to claim 17, wherein the to-be-drawn images contain parts of the basic image with identical size.
